(19) United States
(12) Patent Application Publication
(10) Pub. No.: US 2011/0242630 A1
(43) Pub. Date: Oct. 6, 2011

(54) Beam Multiplier for Multi-LED Lighting Assemblies

(76) Inventor: Gerhard Albert Koepf, Boulder, CO (US)

(21) Appl. No.: 12/754,781

(22) Filed: Apr. 6, 2010

(51) Int. Cl. G02B 5/32; G02F 1/1343

(52) U.S. Cl. 359/17; 359/15; 349/96

(57) ABSTRACT

A beam multiplier operates on lighting assemblies using light emitting diodes (LED) to make their appearance and their illumination field of regard more uniform. It uses holographic gratings to multiply the number of light beams emitted by the LEDs. Fixed or switched holographic gratings can be used in the construction of beam multipliers. Beam multipliers with electrically switched holographic gratings fabricated of liquid crystal materials provide lighting assemblies with selectable static or dynamic modes of operation such as beam widening and sharpening modes, color changing modes and scanning modes.

### BACKGROUND

Light emitting diodes (LED) are replacing conventional light sources in a rapidly growing number of lighting applications. LED sources fabricated for lighting applications generate diverging LED beams with a bell shaped cross section and a typically 20-40 degree wide field of regard. The luminescence of a single LED source is insufficient for many lighting applications. Manufacturers increase the luminescence by using a plurality of LED sources. The invention relates to lighting assemblies using such multi-LED sources for fixed installed and mobile lighting applications.

### BRIEF DESCRIPTION

Lighting assemblies are designed to distribute light over a specific field of regard. Lighting manufacturers arrange groups of LED sources in one or two-dimensional geometries conforming to planar or curved surfaces. Light bulb replacements or other lighting assemblies using groups of LED sources have a field of regard that is the non-coherent superposition of the constituent LED beams. The resulting brightness variations across the field of regard are perceived as hot spots and are undesirable in many lighting applications. For example, when groups of LED sources are used in desk lamps or flash lights as replacements for conventional light bulbs, the non-uniform illumination makes it more difficult to view objects in the field of regard. Furthermore, when looking at such lighting assemblies, viewers perceive the geometrically separated LED sources as hot spots with high luminescence.

Traditional methods to provide a more uniform appearance of light fixtures and a more uniform brightness in the field of regard include the use of light diffusing and/or light scattering materials placed in front of the multi-LED source. These methods may be suitable in lighting applications that require a field of regard greater than 2*Pi steradian. They are less effective in lighting applications requiring a smaller field of regard and in low profile lighting assemblies.

The invention introduces an alternative method to improve the appearance and the brightness uniformity over the field of regard of lighting assemblies using multiple-LED light sources. The method uses a beam multiplier that generates two or more deflected LED beams from each incident LED beam. Its operation differs from traditional light scattering methods. A beam multiplier does not disturb the light beam transmitted from the LED source. The beams generated by the beam multiplier have substantially the same beam divergence and cross section as the incident light beam, but propagate at an angle relative to the axis of the incident LED beam. When positioned in the beam of a single LED source, the beam multiplier creates the perception of a light source comprised of a number of less luminous virtual LED sources separated from each other. When positioned in front of a multi-LED source, the beam multiplier multiplies the number of hot spots and reduces their brightness, thereby generating a substantially more uniform field of regard.

The invention further introduces a method to actively control beam multiplier characteristics, such as the beam multiplication factor and the beam deflection angles. This method affords light assemblies the ability of being operated in different modes of operation. These modes of operation can be used to provide a range of lighting scenarios from a single lighting assembly.

### DESCRIPTION OF FIGURES

FIG. 1 Side view of an LED transmitting an LED beam and an observer looking at the brightness profile in the field of regard.

FIG. 2. Side view of a linear array of three LEDs transmitting three LED beams

FIG. 3. Brightness profile of a linear array of three LEDs showing three hot spots in the field of regard.

FIG. 4a. Side view showing a beam multiplier with a multiplication factor of two operating on a single incident LED beam; an observer perceives the number of LED sources and the number of hot spots multiplied by two.

FIG. 4b. Side view showing a beam multiplier with a multiplication factor of three operating on a single incident LED beam; an observer perceives the number of LED sources and the number of hot spots multiplied by three.

FIG. 5. Side view showing a beam multiplier with a multiplication factor of two, operating on three incident LED beams transmitted by a linear array of three LED sources.

FIG. 6. Side view of two cascaded beam multipliers, each with a multiplication factor of two operating on an incident LED beam and generating four deflected beams represented by their beam axes.

FIG. 7a. Appearance of a linear array of seven LED sources when operated on by two cascaded beam multipliers with multiplication factors of two and equal deflection angles; one beam multiplier is oriented along the axis, and the other beam multiplier is oriented perpendicular to the axis of the linear array, respectively.

FIG. 7b. Appearance of a linear array of seven LED sources when operated on by two cascaded beam multipliers with multiplication factors of two and equal deflection angles; one beam multiplier is oriented at positive 45 degrees and the other beam multiplier is oriented at negative 45 degrees to the axis of the linear array, respectively.

FIG. 8. An assembly view of a polarization grating comprised of a liquid crystal material between two transparent plates with transparent electrodes with control leads.

FIG. 9a. A beam multiplier electrode pattern with two concentric multiplier zones, control leads, wire bundle and zone controller.

FIG. 9b. A beam multiplier electrode pattern with nine square multiplier zones, control leads, connecting wire bundles, and zone controller.

### DETAILED DESCRIPTION

### 1. Beam Multiplier Operation

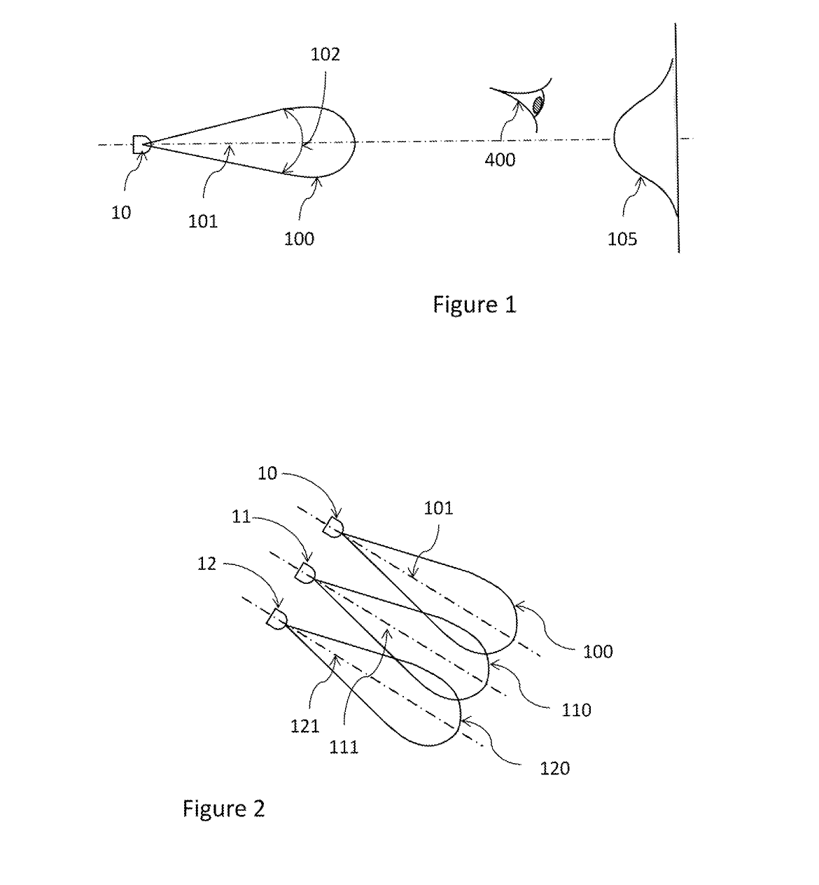

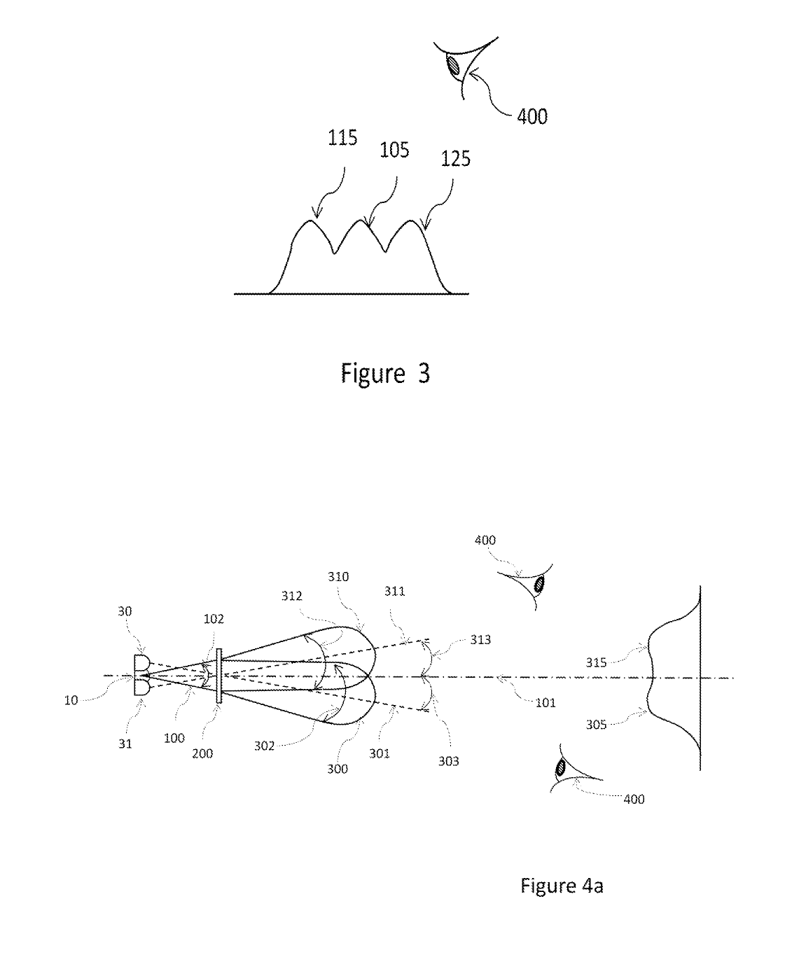

The following discussion presents a more technical description of the operation of a beam multiplier for use in multi-LED lighting assemblies. FIG. 1 shows a single LED source 10 transmitting light beam 100 with beam axis 101 and beam width 102. The far field of beam 100 has a bell shaped brightness cross section 105. Viewer 400 observes this beam as a single hot spot. When two or more LED sources are grouped together in a light fixture the appearance of hot spots is more apparent. FIG. 2 shows three LED sources arranged in a linear array: LED source 10 transmits light beam 100 with beam axis 101, LED source 11 transmits light beam 110 with beam axis 111, and LED source 12 transmits light beam 120 with beam axis 121. Observer 400 of the far field in FIG. 3 perceives the far field as comprised of three hot spots, hot spot 105, hot spot 115, and hot spot 125.

The invention aims at reducing or eliminating the appearance of hot spots in the field of regard of such multi-LED lighting assemblies. This is accomplished by positioning a beam multiplier in front of the multi-LED source providing a beam multiplication factor, one or more beam deflection angles, and a deflection efficiency for each deflected LED beam. The beam multiplication factor determines the number of beams transmitted by the beam multiplier for each incident LED beam. The one or more beam deflection angles relate to the propagation axes of the multiplied LED beams. The deflection efficiency characterizes the brightness reduction of the deflected beams resulting from the multiplication relative to the brightness of the real incident LED beam.

The use of the beam former is neither limited to any specific geometrical arrangement of LED sources nor any specific kind of LED source in the multi-LED lighting assembly. It may be used in lighting assemblies comprising white light sources, single color LED sources, or a mix of color and/or white light LED sources.

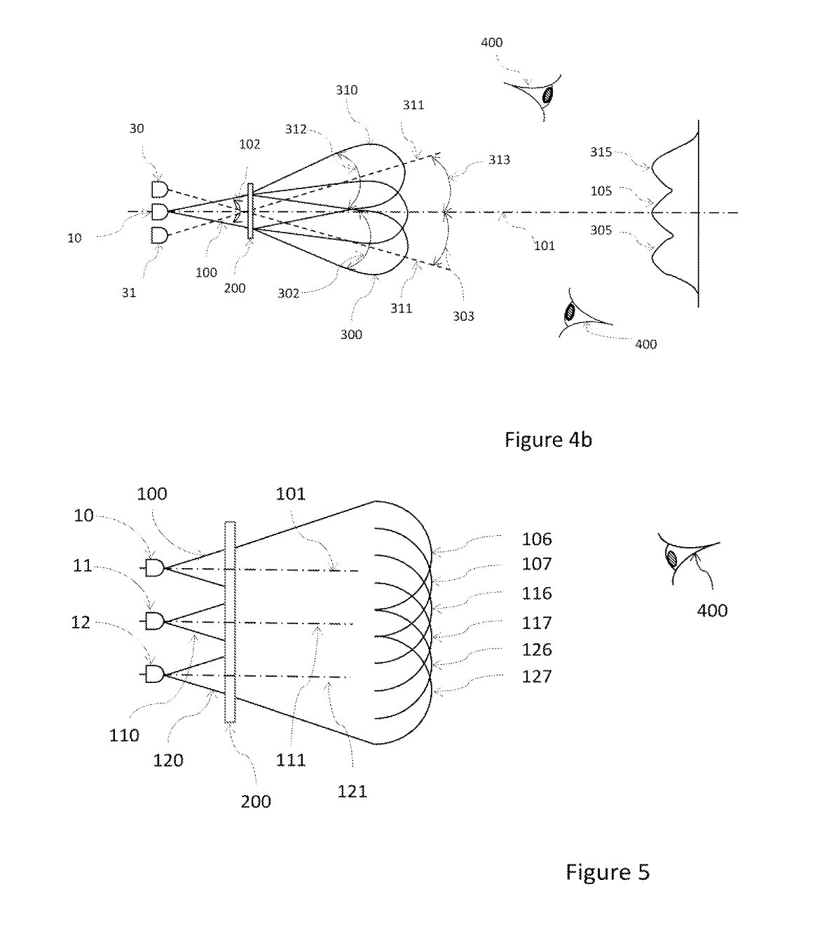

FIG. 4a shows an example were beam multiplier 200 with a multiplication factor of two, deflection angle alpha and 50 percent deflection efficiency for both deflected beams operates on single LED source 10, with beam 100 having a beam axis 101 and a beam width 102. Beam multiplier 200 modifies the appearance of the light source to an observer, effectively generating the perception that single LED 10 has been replaced by virtual LED source 30 and LED source 31, each with ½ the brightness of real LED source 10. First deflected LED beam 300 has beam axis 301, beam width 302 and beam deflection angle 303 with respect to LED beam axis 101; and second deflected LED beam 310 has beam axis 311, beam width 312 and beam deflection angle 313 with respect to LED beam axis 101. Beam widths 302 and 312 are the same as beam width 102. Deflection angles 303 and 313 are the same, but have opposite signs with respect to beam axis 101, and are equal to beam multiplier deflection angle alpha. An observer of the far field of this LED source when modified by the beam multiplier perceives two hot spots, hot spot 305 and hot spot 315.

FIG. 4b shows a second example using a multiplication factor of three, deflection angle alpha, and a deflection efficiency of 33 percent for each of the three deflected beams. Beam multiplier 200 deflects incident LED beam 100 with zero deflection angle. Second deflected beam 300 has beam axis 301, beam width 302 and deflection angle 303, and third deflected beam 310 has beam axis 311, beam width 312 and deflection angle 313. Observer 400 in the far field perceives three hot spots: hot spot 105 comes from real LED source 10, hot spot 305 comes from virtual LED source 30 and hot spot 315 comes from virtual LED source 31. Observer 400 perceives a field of regard that is essentially identical to a light source comprising three LED sources shown in FIG. 3.

As an example of operating a beam multiplier with a linear array of LED sources, FIG. 5 shows a section of a linear array of LED sources comprised of three essentially identical LED sources spaced by distance D. LED sources 10, 11 and 12 transmit diverging beams 100, 110 and 120 with beam axes 101, 111 and 121, respectively. Beam multiplier 200 has a multiplication factor of 2, deflection angle alpha and near 50 percent diffraction efficiency fbr each deflected beam. It is oriented such that beam multiplication occurs in the plane that encompasses the linear array and the beam axes 101, 111 and 121.

Furthermore, beam multiplier 200 is positioned at a distance d from the LED sources such that LED beams 100, 110 and 120 do not substantially overlap in the plane of the beam multiplier. Beam multiplier 200 multiplies beams 100, 110 and 120 into six beams with half the brightness of the incident beams. Beams 106, 116 and 126 propagate at the deflection angle alpha to the left, or to one side, and beams 107, 117 and 127 propagate at the deflection angle alpha to the right, or to the opposite side, relative to beam axes 101, 111 and 121, respectively. To an observer of the array comprised of three real LED sources, the array appears to be comprised of six virtual LED sources. Likewise, the number of hot spots in the far field has doubled from three to six, and each of the six hot spots has a brightness that is reduced by one half compared to the brightness of the hotspots generated by the array of real LED sources.

The relative spacing Dv of virtual LED sources generated by the beam multiplier depends on the spacing D of the real LED sources in the array, the distance d between the LED array and the beam multiplier, and the beam multiplier deflection angle alpha. For the special case, where alpha=arctan D/(4*d). Dv=D/2. The observer perceives a field of regard as provided by a light fixture with twice the number of LED sources equally spaced by Dv=D/2, but with half the brightness of the real LED sources.

Alternatively, when beam multiplier 200 in FIG. 5 is oriented in an orthogonal direction to the plane encompassing the LED array and beam axes 101, 102 and 103, the appearance of the array changes to one where pairs of virtual LED sources spaced by distance Dv=d*tan(alpha) orthogonal to the array axis are spaced by distance D in the array axis.

In these examples, beam multipliers with multiplication factors of two and three were used to illustrate the basic method of beam multiplication. It follows, that beam multipliers with larger multiplication factors, more than one deflection angle, more than one orientation, and a range of deflection efficiencies can be operated in substantially the same way as shown in the examples to provide further improvements in the appearance of the light assemblies and in their brightness uniformity over the field of regard.

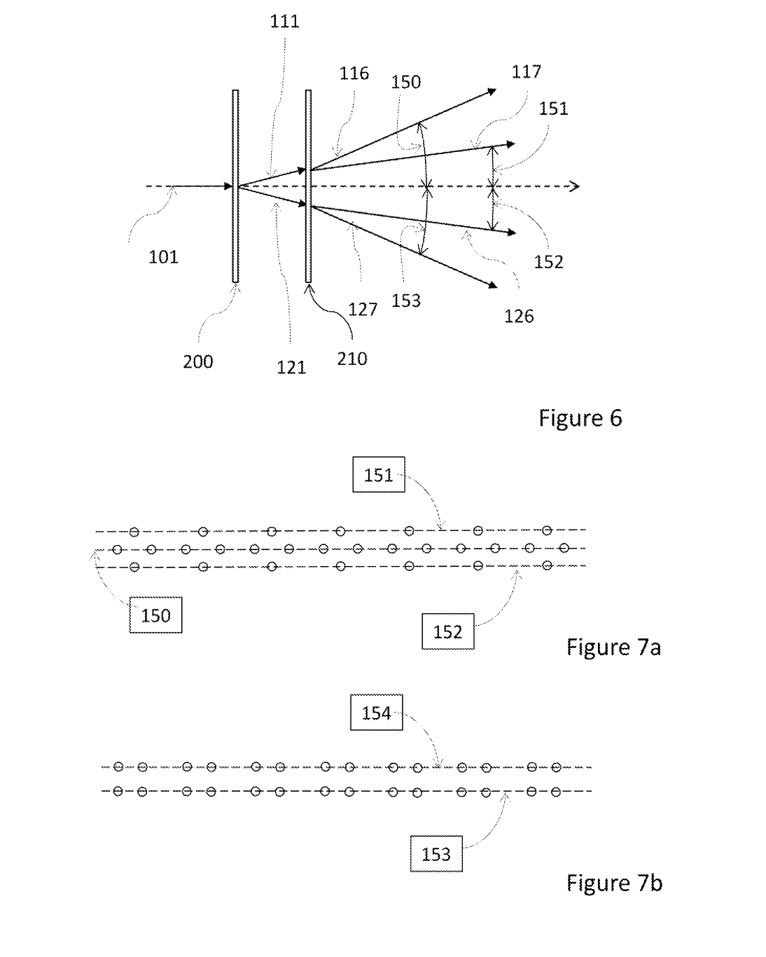

Further, it follows that higher multiplication factors can be realized by using two or more cascaded beam multipliers each having a low multiplication factor. FIG. 6 shows an example of operating two cascaded beam multipliers operating on a LED beam. For clarity, cascaded beam multiplier 200 and 210 are shown separated by a distance, and beams are represented by their beam axes only.

First beam multiplier 200 has a multiplication factor of two, deflection angle alpha and deflection efficiency of 50 percent. Second beam multiplier 210 has a multiplication factor of two, deflection angle beta, deflection efficiency of 50 percent and is positioned in close proximity to beam multiplier 200. Beam multipliers 200 and 210 are shown having the same orientation. Incident LED beam with beam axis 101 is multiplied by beam multiplier 200 into two deflected beams with beam axes 111 and 121 at deflection angle alpha. Each of these deflected beams is incident on second beam multiplier 210.

The combined action of cascaded beam multipliers 200 and 210 is a multiplication of incident LED beam into four deflected beams with beam axes 116, 117, 126 and 127. Beam axis 116 is deflected by angle 150, equal to alpha+beta with respect to axis 101, beam axis 117 is deflected by angle 151 equal to alpha−beta with respect to axis 101, beam axis 126 is deflected by angle 152 equal to −alpha+beta with respect to angle 101, and beam axis 127 is deflected by angle 153 equal to −alpha−beta with respect to beam axis 101. The four deflected beams have a substantial brightness equal to ¼ of the incident beam.

When applied to a one-dimensional array of LED sources equally spaced by distance 1), the cascaded beam multiplier in FIG. 6 may be used to change the appearance of the light source to one comprising four times the number of LED sources equally spaced by D/4. This is achieved with both cascaded beam multipliers oriented in the same direction, when the first cascaded beam multiplier has a deflection angle alpha equal to arctan(D/(4*d1)) and second cascaded beam multiplier has deflection angle beta equal to arctan(D/(8*d2)), where d1 is the distance between the LED sources and the first beam multiplier and d2 is the distance between the LED sources and the second beam multiplier.

Alternatively, the two cascaded beam multipliers may be oriented in orthogonal directions for generating a light source where four virtual LED sources replace every real LED source in a variety of patterns. FIG. 7 shows two such patterns where LED sources are represented by small circles. In FIG. 7a the first of the two cascaded beam multipliers is oriented to generate deflected beams in the plane containing the single row of real LED sources 15 and the second cascaded beam multiplier is oriented to generate deflected beams in an orthogonal plane. The virtual array generated by this beam multiplier has the appearance of a two-dimensional array with additional rows 151 and 152, each with the same number of virtual LED sources as the real number of LED sources, while row 150 has twice the number of virtual LED sources. In FIG. 7b, the two orthogonally oriented cascaded beam multipliers are oriented to generate deflected beams in planes tilted at 45 degrees relative to the plane containing axis 150. The virtual array generated by this orientation of cascaded beam multipliers has the appearance of two rows of LED sources 153 and 154, each with twice the number of virtual LED sources compared to the number of real LED sources in the array.

From these examples one may project the use of single or cascaded beam multipliers in lighting assemblies using multi-LED sources arranged in two dimensions. By selecting the multiplication factors, the deflection angles and the orientations of the cascaded beam multipliers, the appearance of the lighting assembly and the field or regard may be controlled in a wide range of patterns. In extension of the example shown in FIG. 7b, two orthogonally oriented cascaded beam multipliers operating on a square grid of LED sources with spacing D may be used to generate a square grid of virtual LED sources. The virtual LED grid is rotated by 45 degrees and the grid spacing of the virtual LED sources is equal to D/√2 if the deflection angles of the two cascaded beam multipliers are equal to arctan(D*√2/(4*d)).

The spacing of the virtual LED sources relative to the real LED sources for a given beam multiplier deflection angle increases with distance d between the one or more beam multipliers and the LED array. It follows that the distance d may be used as a design parameter for light assemblies using beam multipliers.

For clarity only, up to this point the presentation of operating beam multipliers in multi-LED light assemblies assumed LED beams do not essentially overlap at the location of the beam multiplier. In practice, there is no such restriction for geometrically large beam multipliers operating on a multi-LED source, as their operation at any point is independent of the origin of a particular incident LED beam. Therefore, beam multipliers that operate on a group or array of LED sources may also be placed further away from the LED sources at a position where multiple LED beams overlap.

Furthermore, distance d contributes to the depth of the light assembly. For some lighting applications, one may chose to place the beam multiplier close to the multi-LED source to achieve a low profile. In other lighting assemblies, where groups of LED sources are arranged on a curved surface, one might chose to use a separate beam multiplier for each LED source, preferentially integrating the beam multipliers with the LED source.

### 2. Beam Multiplier Embodiments

Beam multipliers of the invention operate differently on LED beams than other known methods used to improve the uniformity of illumination over the field or regard. These known methods use scattering and diffusing devices to distribute the LED beams over a wider field of regard. The invention allows for use of beam multipliers in combination with such scattering and diffusing methods and devices without limitation.

Persons skilled in the field of optics are familiar with optical components and devices applicable for embodiments of beam multipliers. According to the invention, beam multipliers used in multi-LED lighting assemblies preferentially operate in transmission, are planar devices, have a thin profile, and can be inexpensively fabricated in large quantities. For these reasons, the preferred embodiment of beam multipliers uses diffraction gratings that operate on the phase of the light rather than the amplitude. Thick- or volume gratings have been proven to achieve near 100 percent diffraction efficiencies for wideband light sources.

Commercial LED sources generally transmit randomly polarized beams that may be viewed as a superposition of two orthogonally polarized beam components of substantially the same brightness. Volume gratings exhibit a more or less pronounced dependency on the polarization of the incident beam. This causes the diffraction efficiency for one polarization state to be different from the diffraction efficiency for the other polarization state. While this may be acceptable in some beam multiplier applications, volume phase gratings may not always yield the desired results.

The preferred embodiment of the beam multiplier uses a special case of volume grating, called polarization grating. This type of grating operates on the polarization state of the incident light beam. A polarization grating deflects a right hand circularly polarized incident beam with near 100 percent deflection efficiency into a first positive grating order, and a left hand circular polarized incident beam with near 100 percent deflection efficiency into the first negative grating order. The polarization grating therefore operates on a randomly polarized LED beam essentially as the beam multiplier shown in FIG. 4a, whereby the multiplier deflection angle is equal to the grating angle and the deflection efficiency for each of the deflected beams is near 50 percent.

Known materials and fabrication methods allow the fabrication of large area volume or polarization gratings with multiplication factors of two or higher in one or two dimensions and a range of grating angles. In one of the preferred embodiments, polymer polarization gratings, the grating is fabricated using a photosensitive polymer or gel material that is sandwiched between two transparent plates with antireflection coatings. The grating is recorded in the polymer using holographic techniques followed by a curing process.

Another known material for fabricating polarization gratings with high deflection efficiency over wide grating angles is a nematic liquid crystal (LC) material, sandwiched between two transparent plates, LC polarization gratings. During the fabrication process, an alignment layer is applied on the sides of the transparent plates that contact the LC material. The recording of the birefringent grating structure uses known holographic exposure techniques.

Both, polymer polarization gratings and LC polarization gratings can be fabricated in large areas with targeted beam multiplier properties, such as multiplication factor, grating orientation, grating period, and deflection efficiencies. Likewise, both types of polarization gratings may be cascaded to achieve a wide range of beam multiplier uses.

### 3. Switched Beam Multiplier Description

The birefringent polarization grating structure recorded in LC materials can be erased by applying an electric field across the LC material. When the electric field is removed, the liquid crystals realign themselves in the original birefringent grating structure. It is an objective of this invention to use this feature in lighting assemblies using beam multipliers to introduce additional controls for the field of regard. Active control of beam multipliers using liquid crystal polarization gratings is enabled by disposing transparent electrodes to the two transparent plates enclosing the LC material. The electrodes are connected to a zone controller via connecting wires to apply a switching voltage.

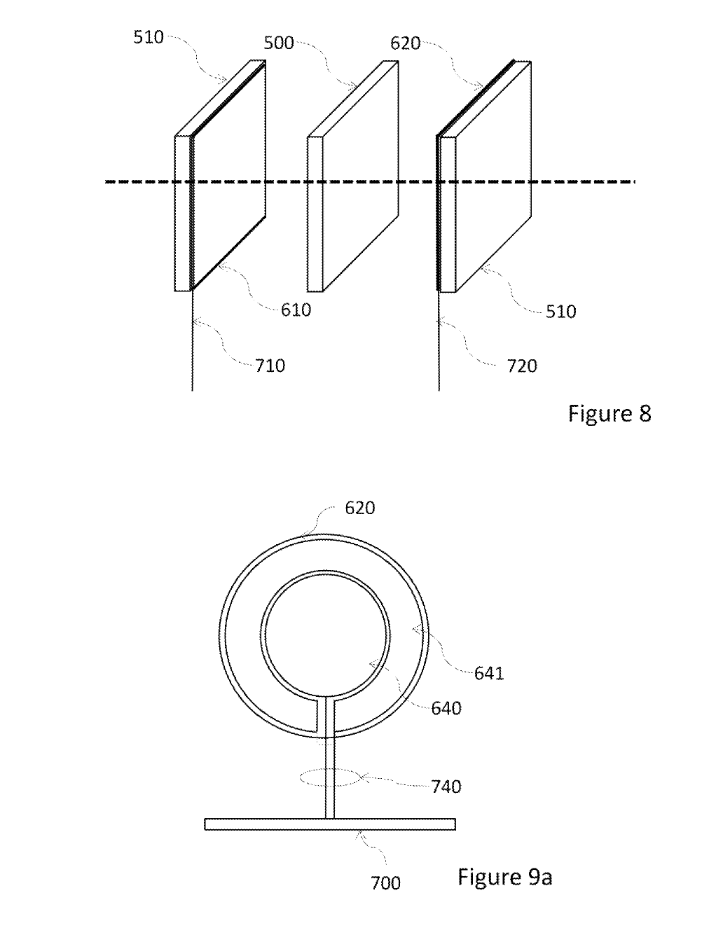

FIG. 8 shows a switched beam multiplier assembly using a switched polarization grating where the components are spread apart for illustration purposes only. The liquid crystal polarization grating 500 is sandwiched between transparent plates with antireflection coatings 510. Plates 510 have transparent conducting films 610 and 620 that are connected to connecting wires 710 and 720, respectively. Conducting film 610 may be considered to be a ground electrode, while conducting film 620 may be considered to be a control electrode. When a control voltage is applied across the connecting wires, the polarization grating is erased. Without the birefringent grating structure, an incident LED beam passes through the beam multiplier without deflection and with near 100 percent efficiency. When the control voltage is turned off, the beam multiplier returns to its original birefringent state.

According to the invention, switched beam multipliers can be used to provide multiple-LED lighting assemblies with various modes of operation. In switched beam multiplier applications, the beam multiplier is partitioned into one or more multiplier zones. Each multiplier zone is defined by a set of transparent electrodes and control leads for controlling the zone. A zone controller is electrically connected to the plurality of zone leads providing control voltages. By switching control voltages for one or more of the multiplier zones on or off, the zone controller may thus be used to change the appearance of the multi-LED lighting assembly and the brightness distribution in the field of regard.

The number of zones in a switched beam multiplier depends on the use of the lighting assembly. A single zone may be used to actively control the field of regard of the entire multi-LED source. For example, a beam multiplier comprised of two cascaded switched polarization gratings with different grating angles, can provide four modes of operation depending of the switching states of the two gratings.

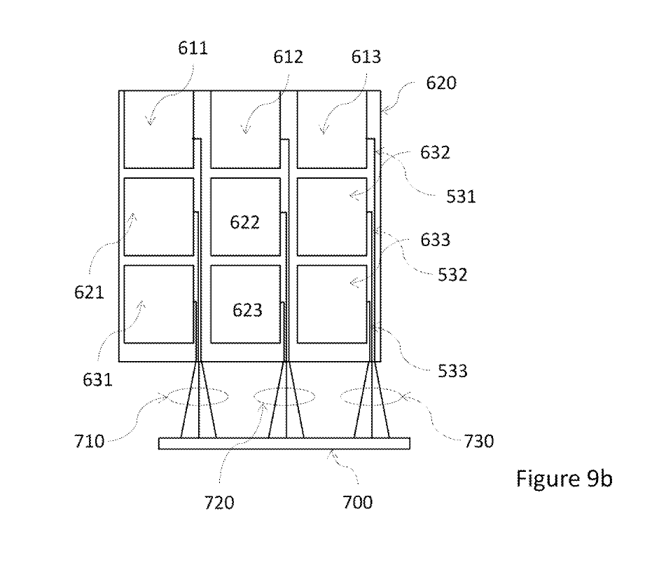

Alternately, zones may be sized to intercept only one of the LED beams for individual control of LED beams or sized to operate on selected groups of LED beams. For example, FIG. 9a shows the transparent conducting film structure 620 for a switched beam multiplier with electrodes 640 and 641, each connected via a control wire enclosed in wire bundle 740 to zone controller 700. In combination with a ground electrode on the second transparent plate, electrode 641 provides control of the perimeter, and zone 640 provides control of the center of the field of regard, respectively.

FIG. 9b shows a second example where the transparent conducting film 620 is patterned into a grid comprising nine zones 611-633 and their control leads. Each thin film electrode is connected via a control lead to a contact pad preferentially at the edge of the beam multiplier. In FIG. 9b conducting leads 531, 532 and 533 are shown connected via connecting wires attached to the contact pads to zone controller 700. Wire bundle 730 comprises the connecting wires for conducting leads 531, 532 and 533. Electrodes 611, 612 and 613, as well as, 621, 622 and 623 are likewise connected to zone controller 700 via conducting leads and wire bundles 710 and 720.

One or more transparent ground plane electrodes are patterned on the side of the liquid crystal polarization grating opposite to the electrodes forming the zones. One or more ground planes are also electrically connected to zone controller 700. FIG. 9b provides individual control of nine beam multiplier zones, each of which may be operating on at least one or more LED sources.

In other applications, the beam multiplier may be partitioned into a number of zones that is larger than the number of LED sources and each LED beam is intercepted by a plurality of individually controllable zones. In these applications, each zone may have a separate or a shared control lead. The plurality of control leads may be mapped 1:1 into a plurality of connecting wires or control leads may be grouped to form non-contiguous groups of zones sharing control wires.

The zone controller may have two dimensional voltage patterns stored in memory. Each voltage pattern activates one mode of operation for the lighting assembly. Voltage patterns may be static or dynamic to provide certain illumination conditions in the field of regard.

Static modes of operation may include a beam sharpening mode, a beam widening mode and a mode that changes the color distribution in the field of regard. In a beam sharpening mode, the beam multiplier operates on the LED sources located at the perimeter of the lighting assembly differently than on the LED sources in the center. In a beam widening mode, the beam multiplier may activate the largest available deflection angles for the plurality of zones. In a scattering mode of operation, the beam multiplier may apply a coordinated or random pattern of deflection angles across the plurality of zones.

For a fixed grating period, the longer wavelength light components of LED beams are deflected into larger deflection angles than short wavelength components of LED beams. This grating dispersion characteristic effects the color distribution in the field of regard. Switched beam multipliers with and without partitioning into multiplier zones may thus be used to implement color distribution modes.

One example for a dynamic voltage pattern is a scanning mode of operation, whereby groups of zones are switched in sequence using a coordinated voltage pattern. Another dynamic voltage pattern applies a plurality of random voltage sequences to the beam multiplier, with a switching rate that is not perceptible to the human eye, effectively generating a dynamic scattering mode of operation.

For selecting modes of operation, the zone controller in the lighting assembly may be comprised of a manually operated switch, or an infrared or radio frequency receiver for remote control.

The invention shall not be limited to the particular examples of switched beam multipliers or modes of operation given above. The method of using switched beam multipliers in combination with a zone controller may be applied to create a wide range of other modes of operation in multi-LED lighting assemblies.

What is claimed:

1. A beam multiplier for use in lighting assemblies using one or more light emitting diode (LED) sources for transmitting LED beams, comprising one or more cascaded holographic gratings for controlling the illumination field of regard.

2. A beam multiplier as in claim 1, whereby the one or more cascaded holographic gratings comprise periodic spatial modulations in one or more directions.

3. A beam multiplier as in claim 2, whereby the one or more cascaded holographic gratings are characterized by a multiplication factor, an orientation and one or more deflection angles.

4. A beam multiplier as in claim 3, whereby the one or more cascaded holographic gratings operate on one or more incident LED beams of the lighting assembly by generating deflected LED beams.

5. A beam multiplier as in claim 4, whereby incident LED beams are multiplied into a number of deflected beams equal to the product of the multiplication factors of the one or more cascaded holographic gratings.

6. A beam multiplier as in claim 4, whereby the deflected beams have beam axes that are determined by the orientations and the deflection angles of the one or more cascaded holographic gratings.

7. A beam multiplier as in claim 4, whereby two or more cascaded holographic gratings with one-directional periodic special modulations have their orientations rotated with respect to each other to provide the function of a multi-directional periodic structure.

8. A beam multiplier as in claim 2, whereby at least one of the cascaded holographic gratings is a polarization grating.

9. A beam multiplier as in claim 8, whereby the at least one polarization grating is fabricated using a photosensitive polymer material.

10. A beam multiplier as in claim 8, whereby the at least one polarization grating is fabricated using a liquid crystal material.

11. A beam multiplier as in claim 10, whereby transparent electrodes are disposed to each side of the liquid crystal polarization grating for applying control voltages.

12. A beam multiplier as in claim 11, further comprising a zone controller electrically connected to the transparent electrodes providing control voltages.

13. A beam multiplier as in claim 11, whereby the transparent electrodes on at least one side of the liquid crystal polarization grating are patterned to from a plurality of beam multiplier zones.

14. A beam multiplier as in claim 13, whereby beam multiplier zones include individual or shared transparent conducting leads for electrical connections to the zone controller.

15. A beam multiplier as in claim 14, whereby beam multiplier zones operate on one or more incident LED beams.

16. A beam multiplier as in claim 12, whereby the zone controller applies one or more static zone control voltage patterns to the plurality of beam multiplier zones corresponding to static modes of operation.

17. A beam multiplier as in claim 16 whereby one of the static modes of operation is a beam sharpening mode.

18. A beam multiplier as in claim 16, whereby one of the static modes of operation is a wide-angle mode.

19. A beam multiplier as in claim 16, whereby one of the static modes of operation is a color distribution mode.

20. A beam multiplier as in claim 12, whereby the zone controller applies time varying voltage patterns to the plurality of beam multiplier zones corresponding to dynamic modes of operation.

21. A beam multiplier as in claim 20, whereby the time varying voltage patterns are random voltage patterns changing at a rate that is imperceptible to the human eye.

22. A beam multiplier as in claim 20 whereby the time varying voltage patterns are coordinated in time providing a beam scanning mode of operation.

23. A beam multiplier as in claim 10, whereby the zone controller cooperates with an LED source controller controlling the brightness of the one or more LED sources to effect a plurality of modes of operation.
